(19) United States
(12) Patent Application Publication
(10) Pub. No.: US 2026/0337101 A1
(43) Pub. Date: Oct. 29, 2026

(54) A method for manufacturing textile reinforcement for concrete structures and a device for carrying out the method

(71) Applicant: Fiber Elements GmbH, Leoben (AT)

(72) Inventors: Wolfgang FIEL, Wien (AT); Werner METZLER, Lustenau (AT); Rafael LUDESCHER, Wien (AT)

(21) Appl. No.: 19/632,037

(22) Filed: Mar. 27, 2026

(30) Foreign Application Priority Data
Mar. 31, 2025 (EP) 15167505.4

(51) Int. Cl. C04B 20/00; D04B 21/16

(52) U.S. Cl. CPC C04B 20/0048; D04B 21/165; D10B 2505/02; D10B 2505/204

(57) ABSTRACT

A method for manufacturing a textile reinforcement for concrete structural elements, wherein, in a first method step, a flat substrate is provided, which is coated in a second method step with rovings (25) that are secured to the substrate in a third method step using a fastening thread (47) with a textile knot (40, 44) on the substrate (13), wherein the substrate is formed as an open-mesh geogrid (13) consisting of intersecting grid bars (27), and wherein, in the third method step, the rovings (25) are secured to the grid intersection points (26) of the geogrid (13) by means of a loop knot (40) of the fastening thread (47).

### CROSS REFERENCE TO RELATED APPLICATIONS

This application claims the benefit of priority to European Patent Application No. 15167505.4, filed Mar. 31, 2025, the entire contents of which is incorporated herein by reference in its entirety.

### TECHNICAL FIELD

The invention relates to a method and a device for producing reinforcement on an open-mesh substrate, specifically using a basalt geogrid substrate.

In this specific case, the invention relates to a basalt substrate with fiber bundles arranged on it in a manner suited to the load conditions for reinforcing concrete, without the use of additional substrates.

### BACKGROUND

EP3684985B1 (Lohnveredelung Fussenegger & Grabher GmbH; priority date Sep. 20, 2017 “Reinforcement”), a method for manufacturing a reinforcement comprising a grid structure made of rovings is disclosed, wherein a continuous, flat substrate is present, which is dissolved with a solvent immediately after the application and fixation of the rovings. The use of such a substrate is avoided in the present invention.

The publication comprises a flat, soluble substrate, with rovings laid crosswise on the substrate, such that the rovings themselves form intersection points on the substrate. The rovings are secured to one another at their intersection points using a textile fastening thread in a manner similar to embroidery, so that the fastening thread interconnects at least two rovings. The flat substrate serves solely to maintain spacing between the different layers of rovings, thereby creating a three-dimensional reinforcement cage. Once the dissolvable substrate has been laid up with the longitudinal, transverse, and web rovings—which are secured at their intersection points by a thread—the substrate is dissolved.

EP3684985B1 is based on the following manufacturing process.
The substrate is a uniformly flat PVA material
Rovings are laid down only in the X and Y directions, but not in a spatial arrangement
An additional manufacturing process (wet method) is required to dissolve the substrate.
In EP3684985B1, the 2D structure must be sprayed with resin for this purpose in order to maintain its shape (geometry).

This method can only be used to produce dimensionally unstable reinforcement grids, which limits their application, usability, and load-bearing capacity.

In addition to the drawbacks of a complex manufacturing process, this method has the further disadvantage that it uses a large embroidery machine with a bobbin-guided lower thread, which results in disproportionately high costs for the device.

EP637658B1 (Bay Mills Limited; priority date: Jul. 8, 1993, “Open grid fabric for reinforcing a wall system, wall segment product, and method of manufacturing the same”) a method is described for manufacturing a coated open-grid fabric for reinforcement and impact resistance in wall systems, comprising a solid surface and a stucco-like layer, wherein the fabric comprises rovings that are directly sized with a silane-containing sizing agent, and wherein the rovings of the fabric are coated with a polymer resin. The synthetic resin is intended to fix an open lattice structure for the fabric. The use of a synthetic resin should be avoided for environmental reasons.

EP3114288B1 (Dresden University of Technology; priority date: Mar. 4, 2014, “Reinforcement Grid for Concrete Construction”), a reinforcement grid for concrete construction is described, comprising high-performance filament yarns arranged in a first direction, as well as threads arranged in at least one second direction deviating from the at least first direction to form a second thread layer. The two layers of yarn are joined at intersection points to form a textile fabric and feature, at least in part, an encircling thickened section with a ribbed, sawtooth-like surface profile designed to transfer higher forces or stresses into the filament yarns. However, a surrounding thickened section with a ribbed, sawtooth-like surface profile is disadvantageous due to the complex manufacturing process.

DE102015100438B3 (Dresden University of Technology; filing date Jan. 13, 2015, “Manufacture of precast elements from textile-reinforced concrete”) a method for manufacturing precast elements from textile-reinforced concrete is described, wherein a yarn free of polymeric binders is formed into a tensioned fabric in a base frame by means of a laying device, and, in the process, the yarn is laid under mechanical tension between yarn-holding devices arranged on the base frame, wherein the yarn is guided under prestress around deflection pins of the tensioning frame. The tensioned fabric formed from the yarn is two-dimensional, and the yarn is laid by a laying robot. The yarn used consists of a roving made from high-performance filament yarns. It was recognized that the coating is crucial for the internal bonding of the roving (the bond between the individual filaments) and the external bonding to the concrete matrix, and thus for the quality of the concrete component reinforced with the reinforcement grid.

However, one drawback is the use of a tensioning frame in which the yarn is laid down under tension by a laying robot.

### BRIEF DESCRIPTION OF THE DRAWINGS

The invention is described in more detail below with reference to drawings that illustrate only one embodiment. Here, further features and advantages of the invention essential to the invention are apparent from the drawings and their description.

They show:

FIG. 1: Perspective view of a laying machine designed to place rovings on a geogrid and secure them at the grid intersection points.

FIG. 2: A schematic representation of a layer of the geogrid.

FIG. 3: An enlarged, perspective view of the feed head.

FIG. 4: A diagram showing the placement of the laying head over the geogrid, with the layout of the roving strands indicated.

FIG. 5: A schematic and partial representation of a reinforcement cage in which only part of the side wall and part of the bottom wall adjacent to it are shown, with roving strands attached to them.

FIG. 6: A schematic representation of the placement of the roving strands at the grid intersection points of the geogrid, showing an example of an error.

FIG. 7: A preferred embodiment for forming a chain stitch loop to join the geogrid's grid bars together with the roving lying on top of them.

### DETAILED DESCRIPTION

The invention is therefore based on the objective of further developing a method and a device for carrying out the method of the type mentioned above in such a way that a textile reinforcement known from EP3684985B1 is designed to be substantially more load-bearing, so that spacer grid structures that are to be removed later can be dispensed with and the absolute strength of the laid rovings at the intersection points of the geogrid is ensured.

The solution to the problem at hand is provided by the technical teaching of the independent claims.

Unlike the subject matter of EP 3 684 985 B1, the invention does not propose a soluble substrate that, upon dissolution, forms free-standing, three-dimensional roving structures linked together by fastening threads. In contrast, the invention provides from the outset for the roving strands to be fastened to a grid-like geogrid by knotting fastening threads at the grid intersection points of the geogrid. This ensures that the geogrid is retained as a form-defining element. This innovative method results in precise shaping, a particularly strong structure, and, consequently, distortion-free shaping of the two-or three-dimensional reinforcements produced in this manner.

Accordingly, the invention provides that the substrate is configured as an open-grid geogrid consisting of intersecting grid bars, and that, in the third step of the method, the rovings are secured to the grid intersection points of the geogrid using a loop knot of the fastening thread.

A preferred device for carrying out the method provides a device for manufacturing a textile reinforcement for concrete components, wherein a laying machine is arranged above a flat substrate in a manner controlled in at least two spatial axes, the substrate being fastened in a tensioning frame that is controlled to move in at least one spatial plane, and rovings consisting of fiber bundles can be secured to the flat substrate by means of a textile fastening thread with fastening knots, wherein the substrate is formed as an open geogrid consisting of intersecting grid bars, and the rovings are secured at the grid intersection points of the geogrid using a loop knot of the fastening thread.

To explain the measures described in the invention and their associated advantages, the following definitions are provided to facilitate understanding of the invention.

The term reinforcement refers to the reinforcement of concrete components by incorporating materials to increase load-bearing capacity; however, in the present invention, this does not refer to prefabricated profiled bars, but rather to a specially manufactured reinforcement consisting of a combination of fiber bundles, so-called rovings, and an open-grid geogrid, which, in addition to increasing load-bearing capacity, generates many other advantages.

A geogrid used in the manufacture of textile-fiber-reinforced concrete components refers to knot-stiff or knot-fixed grids made of rovings based on geosynthetics or geotextiles. The term “geogrid” is also commonly used instead of “geogrid.” Alkali- and corrosion-resistant fibers made of plastics, bioplastics, natural fibers, glass fibers, carbon fibers, aramid fibers, or, in particular, basalt fibers—or fibers made of non-metallic materials—may be used to achieve the aforementioned benefits in the manufacture of concrete components. The geogrid can be designed as a two-dimensional grid structure or as a three-dimensional reinforcement grid.

The geogrid or any other reinforcement grid made of any other mesh material is held in a tensioning frame in a chain-stitch, embroidery, or laying machine. The fiber bundle is designed for load-specific trajectories based on a finite element analysis and applied to the geogrid using a motorized laying head. Once the laying head has placed such a roving strand at an intersection point of the reinforcement grid, the roving strand is secured at that intersection point, preferably using a loop knot tied with a fastening thread. The loop knot encircles the intersection point of the reinforcing grid bars, thereby securing the roving strand in place at that intersection point. The fastening thread used to form the knot is fed by a two- and/or three-dimensionally driven embroidery tool and transformed into a loop knot using the hook-like end of a stitching needle.

The fiber-reinforced, load-case-specific reinforcement structures produced in this way can be used as either two-or three-dimensional structures. Reinforcement produced using this method not only increases tensile strength but also improves bond strength within the concrete. The lighter weight, higher temperature resistance, and flexibility in spatial design are further advantages of this system.

The term “embroidery tool” refers to the fact that this is not an embroidery tool found in the standard embroidery head of a large-scale embroidery machine, because the stitching needles typically used in large-scale embroidery machines penetrate the fabric and form a thread loop on the reverse side, which is passed through by a bobbin thread guided in a shuttle. Such stitching needles are usually straight and do not have a hooked tip. Accordingly, the invention does not involve a stitching needle that penetrates a fabric base that does not exist. Such a needle according to the invention is more akin to a crochet needle with a hook-shaped head, which is suitable for forming a loop knot—preferably a chain stitch knot—around the roving located at the intersection point of the grid, starting from the top of the substrate; in the method used, this process is more akin to crocheting. Unlike a stitching needle or a knitting needle, a crochet needle has a hook-shaped tip designed to catch a loop of the fastening thread. Nevertheless, taking these differences into account, the term “stitching needle” is used in the following description.

Using this hook, it is possible to pull the fastening thread through the stitches already worked, thereby creating a continuous chain of stitches—in this case, a loop knot.

Fiber bundles (rovings) made from the materials mentioned consist of so-called filaments with a diameter ranging from 6 to over 50 micrometers. A typical bundle consists of approximately 6,000 to 96,000 filaments (carbon) or has a tex rating of 150 to over 4,800 (g/km) (basalt), and is processed in the form of spools with a typical weight of 30 kg and a typical length of over 12 km. The filaments used generally have a base coating of aqueous resin.

A geogrid tensioning frame refers to a frame that mechanically secures a geogrid or other mesh material at the edges, allowing for easy access from both the top and bottom and enabling the material to be tightly tensioned.

The laying machine described in the invention is an NC-controlled system whose laying head precisely and automatically lays the rovings onto an open-mesh substrate (geogrid) that is held taut in appropriate tensioning frames. During the laying process of the rovings, the roving fiber bundles are fastened at the respective intersection points of the geogrid using a fastening thread fed from a stitching tool. The embroidery head of the embroidery tool, with the fastening thread contained within it, is preferably guided onto the grid structure of the geogrid only from above in a point-by-point manner. Therefore, there is no need for a shuttle with a bobbin thread, as is common in large embroidery machines. According to the invention, only the essential components of a large-scale embroidery machine are used to carry out the method, resulting in a significant reduction in overall costs, production time, and maintenance.

This allows the rovings to be applied to the substrate (geogrid) in a dimensionally stable manner via a laying head, in accordance with the load requirements—in some cases while suspended in the air—and secured to the substrate using a single-sided loop knot, preferably a chain stitch knot or another knot that can be tied on one side.

The term “chain stitch embroidery/freehand embroidery” refers to embroidery done without the use of any additional substrate. The control system of the tensioning frame generates predefined, calculated paths and/or geometries tailored to specific load cases between the intersection points of the substrate and the rovings laid on it. Using a computer, optoelectronic positioning, calibration, and optimization methods can be employed to increase precision, respond to any geometric deviations in the geogrids used, and compensate for any tolerances.

A chain stitch embroidery or laying machine according to the invention typically has a working area of 2 m×1 m and can be expanded to several meters—up to 8 m×2 m—by arranging multiple units side by side; this is currently the largest possible area that can be produced. Special tensioning frames are required to tension the base material (geogrid or another open-mesh substrate), along with mounting designed for such long structures.

The term “laying fiber bundles in air onto an open-mesh substrate (geogrid)” further implies that the (bare) fiber bundles can be deposited with precise positioning at the intersection points of the substrate after each individual stitching operation, for example through the targeted application of temperature at a specific location and/or through the application of compressive force. By applying pressure to the knot, the yarn material of the fastening thread can be mechanically compacted in the knot area. Alternatively, or simultaneously, a temperature increase can be applied specifically to the knot area of the fastening thread, preferably using a suitable laser beam. In this process, the laser beam can be directed at the “bare” knot to heat the yarn material in the knot area to a temperature below the melting point.

Alternatively, the temperature and exposure time of the laser beam can be increased to the point where the yarn material in the knot area begins to melt partially.

Finally, another alternative may involve the fastening thread being accompanied by one or more thermoplastic threads that can be melted; these threads surround the outer circumference of the embroidery thread in the longitudinal direction and melt when a laser beam directed at the knot area is applied during the stitching process, wherein the melted material penetrates the material of the knot and solidifies it.

However, the properties of the fibers must not be compromised. Therefore, a primer based on an aqueous resin is preferred, formulated to absorb light in the near-infrared (NIR) range emitted by commercially available NIR LEDs or lasers in the 700 to 1,200 nm range, thereby improving the adhesion of the fiber bundles to the substrate.

It follows from the preferred features of the invention that:

As with EP 3 684 985 B1, it is not necessary to lay a tensioning layer. This allows for creative freedom in the creation of multidimensional structures. This reduces production time and costs, especially since any type of industrially manufactured geogrid can be used.

Placing tensioning layers according to EP 3 684 985 B1—directly into the formwork structure—unnecessarily obstructs the concrete pouring operations.

Accordingly, a preferred feature of the invention is that the fiber bundle, of whatever type, is applied to the tightly tensioned substrate (geogrid) in a load-bearing manner, taking into account the geometry required in the precast concrete element, using a chain stitch and/or crochet technique with a knot-forming fastening thread.

The chain stitch embroidery method can be used to fasten rovings made from any material—whether plastic-based, thermally deformable, or natural—in weights ranging from 12/2 NM to 200/2 NM.

The advantage of the chain stitch embroidery method is that it uses only a single-thread system, thereby reducing the amount of “foreign materials” in the finished product by 50%.

Furthermore, with this technique, the connection between the grid and the laid-down fiber bundle occurs only at their intersection point; thus, there is no constriction of the laid-down roving in the open-mesh sections of the substrate or roving areas, and the connection is additionally secured against displacement.

According to the invention, flat reinforcement mats are first produced, which are then formed into three-dimensional reinforcement cages in a subsequent bending process. This allows the bending process to be adapted to the geometry of the concrete components.

When the knot area is additionally irradiated with a pulsed laser system in conjunction with a thermoplastic yarn that accompanies the roving strand, the laid-down roving is held in position with precise radial accuracy over the openings of the supporting grid structure as well as at the intersection points of the grid with the roving, and—in several extended exemplary embodiments—knot formed there is fixed by mechanical consolidation and/or heat treatment and/or melting of a thermoplastic yarn.

Thanks to this absolutely rigid joint, it is now possible for the first time to mechanically transform two-dimensional structures into three-dimensional reinforced bodies without causing undesirable displacements in the joint area during deformation. This is a key factor in transitioning from a 2D plane to a 3D structure during the preform process.

The diameter of the roving feed and the bundling of the roving into radial patterns can be controlled via the motion control system of the laying head and/or the tensioning frame. (Improved bond with the concrete).

In an extended exemplary embodiment, the roving is wrapped with a thermoplastic thread, which is then fused at the intersection points (base substrate/roving) on both sides of the laid roving using a pulsed laser and cured immediately; this method is used to increase the strength of the knot. This prevents the roving from shifting from its calculated position in subsequent processes, such as the conversion of a 2D structure into a 3D structure, from occurring. This means that rovings ranging from 6 K to 96 K or from 150 tex to 4800 tex can be used.

In the words of an embroidery expert, the invention proposes using a geogrid stretched across a tensioning frame as a virtual embroidery base. The tensioning frame can be driven to move in the X-Y direction, and on the front side, an embroidery or crochet tool is mounted in an X-Y carriage that moves above the tensioning frame; the embroidery or crochet hook—hereafter referred to simply as the “stitching needle”—is guided to each grid point of the geogrid.

The tensioning frame can therefore be driven in the X-Y direction.

When stationary, the stitching needle moves to the next intersection point on the roving geogrid according to the laying radius.

These are approached by control software right from the start of the laying process, which calculates the intersection points.

Using a laying head, strand-shaped rovings are laid in an arc shape onto the grid points of the geogrid. The laying head can be connected to the laying assembly or have its own X-Y drive.

The stitching tool is now moved to a specific intersection point on the geogrid, where a roving has just been deposited by the laying head.

The direction of the roving is determined by the X/X-Y/Y travel path of the tensioning frame.

The stitching needle now primarily forms a chain stitch knot consisting of two loops around the roving to secure it at an intersection point of the geogrid. The X-Y drive of the embroidery tool is then moved forward by one mesh width of the geogrid (while adhering to the required load-case radii), and the same process is repeated at the next node. The embroidery thread is carried along continuously throughout the process.

The advantage of the chain stitch according to the invention is that a shuttle with a bobbin thread is not required; instead, the entire knot-forming process can be performed from above by an embroidery head equipped with a stitching or crochet hook.

For simplicity's sake, this tool is referred to as a “stitching needle,” even though its free end has an upward-pointing hook that is suitable for working with and securing the chain stitch using the fastening thread. Such a tool could also be called a crochet needle.

The invention is therefore not limited to the application of a chain stitch using an upper embroidery tool. With such a top-mounted stitching tool, other stitching methods can also be used that are suitable for securing a fiber-like roving at the intersection point of two intersecting elements. Therefore, any type of blind stitch or loop stitch that does not rely on a bobbin thread can be used to form a loop knot.

However, in another exemplary embodiment, a sub-tool in the form of a hook-shaped or wedge-shaped element may be used at the embroidery head; this element can be used to form the chain stitch loops, which are then attached using the hook-shaped stitching needle.

The advantage of chain stitch loops is therefore the particularly strong bond between intersecting elements, namely between two grid-shaped geogrid bars in conjunction with a roving material placed at the intersection point of these bars, which is secured particularly firmly and without displacement by this type of loop formation because the loop knot can be tightened by appropriately guiding the movement of the stitching needle. Using this hook, it is possible to pull the thread through loops that have already been formed, thereby creating a continuous mesh of spaced-out loop knots.

To make a loop knot in the form of a chain stitch using the crochet technique, first form a chain stitch with the hook end of the stitching needle, then form the yarn into a loop and bring the fastening thread leading to the ball of yarn forward as a new loop. To make a new chain stitch, insert the crochet needle from below behind the yarn and pull it through the loop formed previously.

In a preferred embodiment of the invention, it may be necessary to further secure the loop knot. For this further development, it is planned to perform additional securing steps on the chain stitches already formed with the embroidery tool. It is preferred that such knot reinforcement be achieved using a thermoplastic material, preferably by incorporating into the roving a number of thermoplastically fusible filaments that advantageously wrap around the roving in a spiral pattern or lie parallel to its longitudinal direction along its outer circumference and cover it at least partially.

When these thermoplastic yarns are used together with the roving to reinforce the knot, it is preferable to direct a laser beam at the knot after it has been formed, causing the thermoplastic yarns to melt and the molten material to penetrate the knot, thereby reinforcing it even further.

In another embodiment of the present invention, it may be provided that, instead of using heat-meltable thermoplastic yarn to accompany the roving, other thermoplastic melting methods may be used. One such alternative thermoplastic melting method could involve, for example, spraying a liquid curable material onto the area of the formed chain stitch knot, which then cures in air. This material then behaves like an air-curing adhesive. Alternatively, a UV-curable adhesive can also be used. In another process, the sprayed material can be melted onto the loop knot using a laser beam.

Alternatively, it is possible to heat the stitching or crochet needle using induction or radiation to either heat-treat the “bare” loop knot or melt the loop knot using a thermoplastic material.

Using a suitable machine control system, the laying head can be moved in the X, Y, and Z directions, allowing the embroidery tool fastened to it to target any coordinate on the underlying geogrid and, in particular, to detect the intersections of the grid bars, since it is necessary that the loop knots used to fasten the roving strands be positioned only at the grid intersection points of the grid bars and not outside them. If a connection is made outside the grid intersection points, the strength of the reinforcement cage is compromised, which should be avoided. For this reason, the machine and the resulting device are designed such that the laying head is mounted on an X-Y-Z carriage, which supports the stitching tool head on its underside; the stitching tool head is thus capable of targeting any grid intersection point of the underlying geogrid.

The subject-matter of the present invention results not only from the subject-matter of the individual patent claims, but also from the combination of the individual patent claims with each other.

All information and features disclosed in the documents, including the abstract, and in particular the spatial configuration shown in the drawings, may be claimed as essential to the invention, provided that they are novel, either individually or in combination, relative to the prior art. The use of the terms “essential” or “according to the invention” or “essential to the invention” is subjective and does not imply that the features so designated must necessarily be part of one or more patent claims.

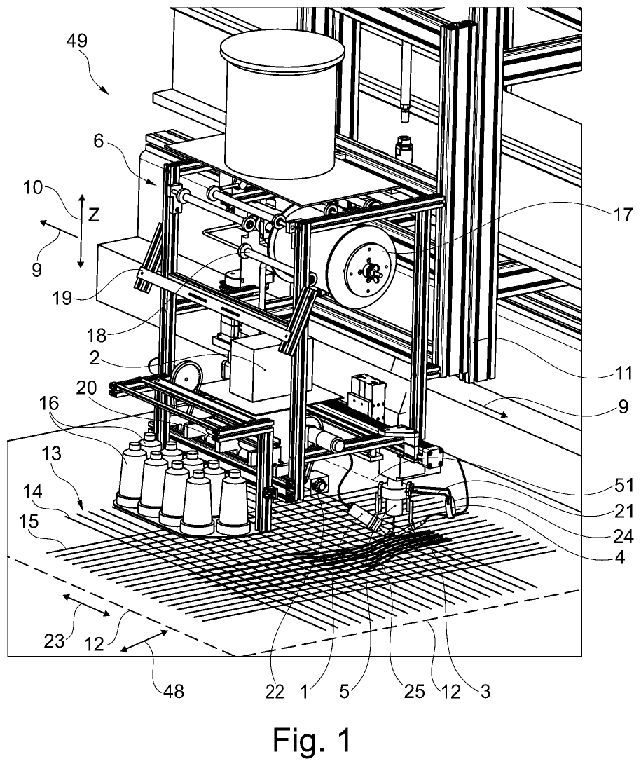

FIG. 1 shows a perspective view of a laying machine 49 for producing two-dimensional reinforcement meshes, in which a carriage frame 6 is mounted on a stationary machine frame 11 so as to be movable in the Z-direction (arrow direction 10) and is driven so as to be movable in the X- and Y-directions (arrow direction 9).

The entire laying machine 49 is positioned above a grid-like geogrid 13, which consists of an upper layer 14 and a lower layer 15; the geogrid comprises a number of grid bars 27 that intersect, preferably at right angles, forming grid intersection points 26 at their junctions.

The geogrid 13 is fastened within a tensioning frame 12, of which only the outer contours are shown as dashed lines. The tensioning frame is preferably driven to move in the directions indicated by the arrows 48 in a horizontal X-Y plane. However, it could also be driven in a direction 23 perpendicular to the direction of the arrow 48, or in both directions 23 and 48. In this way, it is possible to use the laying machine 49 and its carriage drive to position the machine at any grid intersection point 26 on the underlying geogrid 13 and to secure it with a loop knot 40 according to the invention.

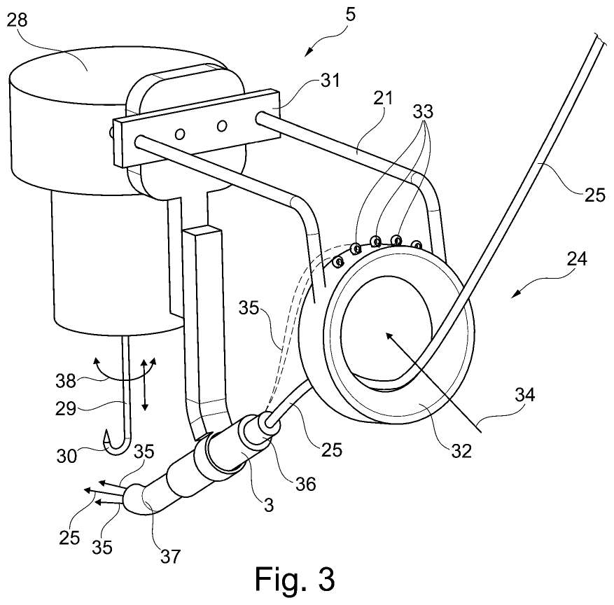

The laying machine 49 preferably consists of the aforementioned carriage frame 6, on the upper side of which a spool 17 for holding the basalt rovings is arranged, wherein the basalt rovings are unwound as a multi-strand rope in a downward vertical direction via a dancer roller 18 and then run in a downward vertical direction along a guide rail (19) (arrow direction 10) into a feed gap of a rotatably driven take-up roller 20, which is opposed by a counter-roller. The roving strand drawn from spool 17 enters the area of the laying head 5 area via the feed plane 51, as shown by the dashed line in FIG. 1, where it is further processed. The roving feed is labeled 24. The details of the laying head 5 are shown in FIG. 3.

The feeding of the rovings beyond take-up roller 20 in feed plane 51 is monitored by an optical sensor 22.

FIG. 1 also shows that the thermoplastic filaments, which are to be fused later, are wound onto yarn spools 16 fastened on the carriage frame 6; these spools accompany the roving strand 25 and are later fused with the formed loop knot 40 by a laser beam emitted from a laser head 1 at the grid intersection point 26.

A second laser power station 2 is also provided to supply power to the laser at laying head 1, as well as a roving feed 3 at laying head 5, which will be discussed in more detail later. There is also a guide 4 for the thermoplastic yarn.

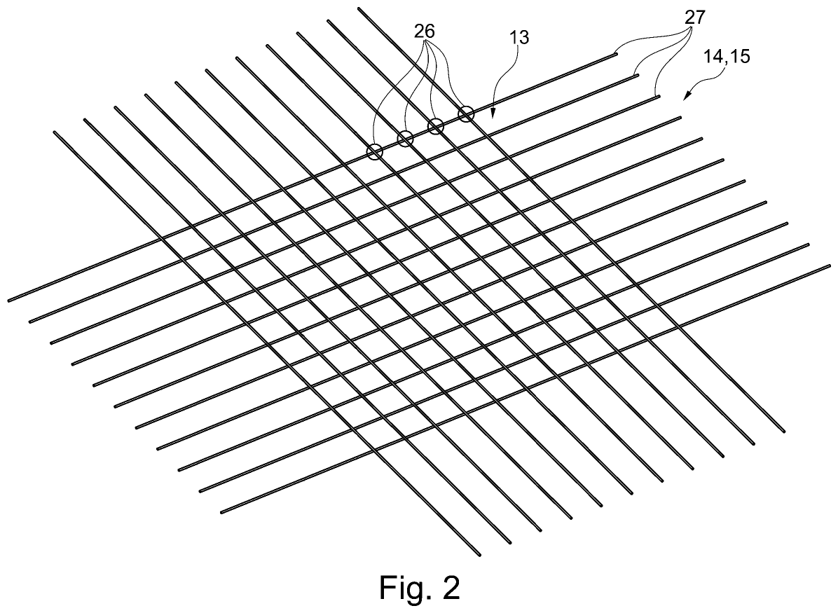

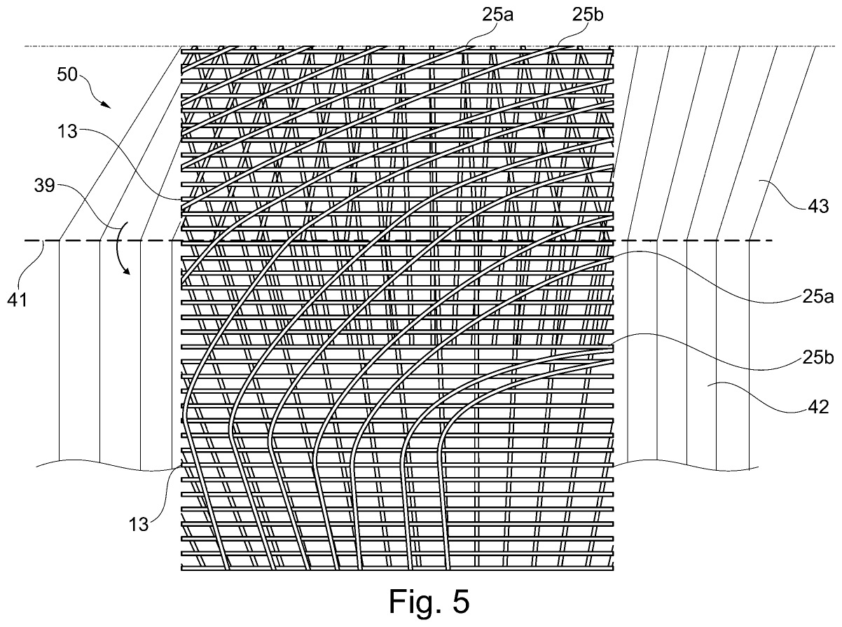

FIG. 2 shows further details of the geogrid 13; however, only one layer is shown, which, following a subsequent forming process, will form either an upper layer 14 or a lower layer 15 of a reinforcement cage 50. It will be shown later that such a flat structure is used to produce a three-dimensional reinforcement cage 50, as illustrated in FIG. 5.

FIG. 2 shows that the grid bars 27 of the geogrid 13 intersect at grid intersection points 26, which later form the nodes for the loop knot 40 to be tied there for the secure fastening of the roving strands 25.

FIG. 3 shows further details of the laying head 5. It can be seen there that the embroidery tool head 28, using a drive mechanism not shown in detail, drives a stitching needle 29 in the directions indicated by the arrows 38 (rotating and translating), with a hook 30 arranged at the outer end of the stitching needle shaft for forming the loop knot 40.

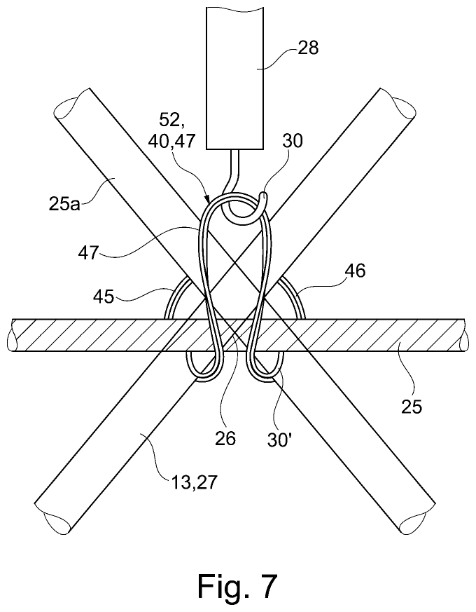

It is not shown that a fastening thread 47 is associated with the hook 30 and the stitching tool head 28; this is shown only in FIG. 7. The fastening thread 47 is carried continuously and uncut from each loop knot 40 to the next loop knot 40.

FIG. 3 shows that the feeding unit for the roving strands at the laying head 5 consists of mounting elements 21, 31 fastened to the stitching tool head 28, to the front free end of which a guide eyelet 32 of larger diameter is fastened, the outer circumference of which is fitted with a number of guide eyelets 33 of smaller diameter. The smaller guide eyes 33 are arranged at regular intervals around the outer circumference of the larger guide eye 32. The diagram shows that at a grid intersection point 26, the roving 25 to be laid is fed through the larger guide eyelet 32 in the direction of the arrow 34, and the thermally meltable yarn in the form of thermoplastic filaments 35 is fed to it as a companion material via the smaller guide eyelets 33 on the outer circumference. The feeder 3 for the rovings is fastened to the stitching tool head 28 via an additional mounting bracket and moves in coordination with it.

Alternatively, the roving feed mechanism 3 may be equipped with a multidimensional drive system separate from the stitching tool head 28.

In the preferred exemplary embodiment shown, the thermoplastic filaments 35 are fed into a mixing head 36 via a separate feed line. The mixing head 36 combines the thermoplastic filaments 35 with the yarn material of the roving 25 in the feed line 3, so that both materials leave the laying head 5 at the outlet 37 of the feed line 3 in contact with one another.

The blended material, consisting of the roving 25 and the thermoplastic filaments 35 encasing the roving 25 longitudinally, enters the area of the stitching needles 29, 30 and is secured there, as shown in FIG. 7, as a loop knot 40 in the preferred form of a chain stitch loop 44 at a grid intersection point 26 of the geogrid 13.

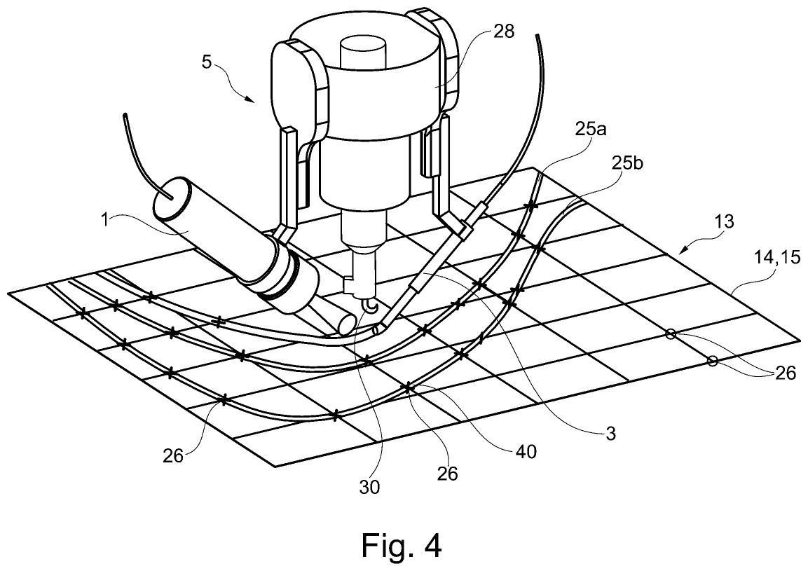

FIG. 4 illustrates the difficulties that can arise when laying the roving strands; for clarity, two roving strands 25a and 25b are shown arranged closely and parallel to one another, as they are laid by the laying head 5 in a precisely defined radius onto the geogrid 13 and its grid bars 27. It is particularly desirable that each roving strand intersects a grid intersection point 26 with precise positioning and is connected there to the grid bar 27 of the geogrid 13 using a chain stitch loop 44.

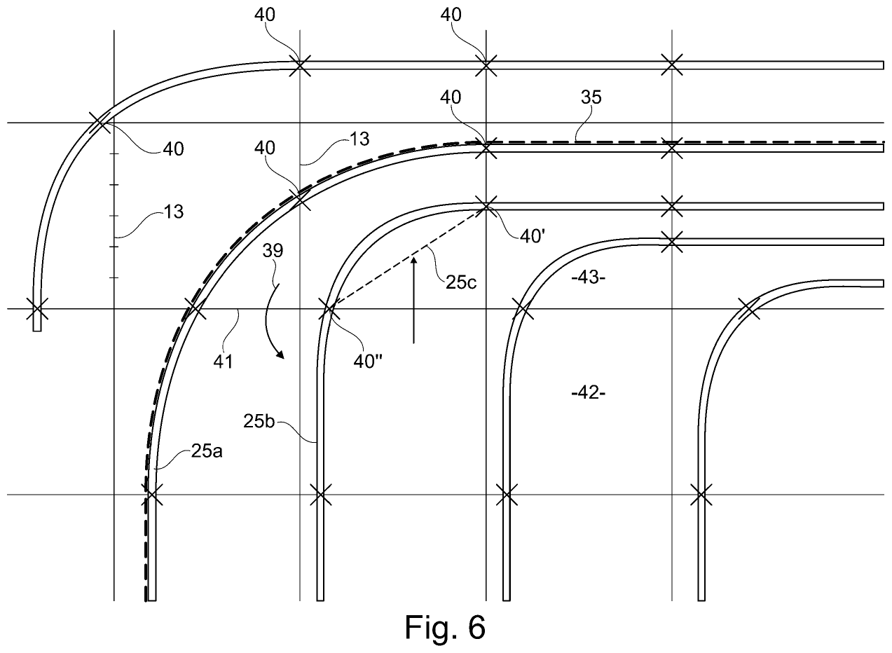

Tests showed that difficulties arose when laying the rovings 25 with precise positioning, as this resulted—as shown in FIG. 6—in layer misalignments or inaccuracies, which could be avoided by implementing the measures described in the invention.

The objective is to position the roving strands 25a and 25b precisely and correctly at the grid intersection points 26 of the grid bars 27 of the geogrid 13 and secure them there with a chain stitch loop 44. However, since, in a first preferred embodiment of the invention, the roving strand is at least partially sheathed by a number of thermoplastic filaments 35, these thermoplastic filaments 35 can now be used to form a thermoplastically fused loop knot 40. For this purpose, a laser head 1 is used, which directs its beam precisely at a grid intersection point 26; after the chain stitch loop 44 has been formed, the laser briefly emits a melting beam onto the chain stitch loop 44 thus formed, which thereby melts into a loop knot 40 that is permeated by the thermoplastically melted material, thereby ensuring that the loop knot 40 is securely fixed in place without any movement.

This is the first time a reinforcement cage 50 has been successfully produced, ensuring exceptional strength, resistance to deformation, and dimensional stability.

Such a fully equipped reinforcement cage 50 is shown partly in the inset of FIG. 5. The figure shows the bottom wall 43 of the reinforcement cage 50 on the top side, while a side wall 42 is connected to it at a right angle via a bend 41. The bend 41 is formed by folding the previously flat grid 13, 27 downward in the direction of the arrow 39, resulting in two planes 42, 43 that are perpendicular to each other. Because the melted loop knots 40 are firmly secured, there is no unwanted movement between the roving strand and the grid intersection point, enabling the 2D grid to be precisely formed into a 3D reinforcement cage 50.

FIG. 5 shows the correct orientation of the roving strands 25a and 25b at the grid intersection points 26 of the geogrid, even when the flat geogrid 13 is folded in the direction of the arrow 39 to form a three-dimensional reinforcement cage 50.

FIG. 6 illustrates potential errors that can occur when folding a panel, such as side panel 42 onto bottom panel 43. For the loop knots 40′, 40″, it is specified that in such undesirable cases, the grid intersection points 26 may form a straight line; that is, the rovings are not routed along the required curve but are instead routed in a straight line along line 25c, which is considered a defect. Such an error is definitely avoided by the technical measures of the present invention, because the laying head 5 is always correctly aligned with the grid intersection points 26 of the geogrid 13.

FIG. 7 illustrates the formation of a preferred embodiment, namely the formation of a chain stitch loop 44, which has the advantage of enabling the creation of elastic seams; however, in the present case, it has the particular advantage that only a single-sided, upper embroidery tool needs to be used, without the need for a shuttle-controlled lower tool.

Of course, there are other ways to attach a fastening loop for tying a loop knot 40, including any blind stitch knots or creating loops using the crochet method.

FIG. 7 does not show that a counter-tool can be used on the underside of the embroidery tool head 28 to form loops, which is also mounted on the embroidery tool head 28.

The chain stitch loop 44 formed here consists of two loops 45 and 46 arranged side by side and parallel to each other, which are connected to one another via a loop 52, thereby forming a closed chain stitch loop 44 that is formed and tightened by the hook 30 of the stitching needle shaft.

Thus, the roving 25 is fixed in place and cannot be displaced at the grid intersection point 26 by the two loops 45 and 46. The figure does not show that the roving could also be accompanied by thermoplastic filaments 35, in order to subsequently achieve further reinforcement of the loop knot 40 formed in this way by melting the thermoplastic filaments 35.

However, the invention is not limited to this. In a simplified embodiment, the loop knot 40 may be formed without using thermoplastic threads 35.

In a derivative embodiment, however, thermoplastic filaments 35 are fed along with the roving in the manner described above, so that they can then be melted by a laser head 1 to form an even better and self-contained loop knot 40.

Overall, it was found that fusing thermoplastic filaments at a loop knot 40 secured by chain-stitch loops creates a reinforcement cage 50 that is particularly resistant to warping and deformation and is capable of withstanding high loads.

### DRAWING LEGEND

1. Laser head
2. Laser power station
3. Feed (roving)
4. Guide (thermoplastic)
5. Laying head
6. Carriage frame
7.
8.
9. X-Y direction
10. Z direction
11. Machine frame
12. Tensioning frame
13. Geogrid
14. Upper layer (of 13)
15. Lower layer (of 13)
16. Thermoplastic yarn spool
17. Spool (basalt roving)
18. Dancer roller
19. Guide rail (for roving)
20. Take-up roller
21. Feeding arm
22. Sensor (roving feed)
23. Arrow direction (tensioning frame)
24. Feed (roving)
25. Roving (laid down and fastened)
   25a. “ ”
   25b. “ ”
   25c “ ”
26. Grid intersection point
27. Bar
28. Embroidery tool head
29. Embroidery needle
30. Hook
31. Mounting
32. Guide eyelet (for 25)
33. Guide eyelet (for thermoplastic)
34. Direction of arrow
35. Thermoplastic filament
36. Mixing head
37. Outlet nozzle
38. Arrow directions (from 29)
39. Arrow direction (from 50)
40. Loop knot 40′, 40″
41. Bend edge
42. Side panel
43. Bottom wall
44. Chain-stitch loop
45. Loop
46. Loop
47. Fastening thread
48. Arrow directions
49. Laying machine (chain-stitch embroidery or laying machine)
50. Reinforcement cage
51. Feed plane
52. Loop

What is claimed is:

1. A method for manufacturing a textile reinforcement for concrete structural elements, wherein, in a first method step, a flat substrate is provided, which is, in a second method step, covered with rovings (25) that are, in a third method step, secured to the substrate (13) using a fastening thread (47) with a textile knot (40, 44), characterized in that the substrate is formed as an open-mesh geogrid (13) consisting of intersecting grid bars (27), and that in the third step of the method, the rovings (25) are secured to the grid intersection points (26) of the geogrid (13) using a loop knot (40) of the fastening thread (47).

2. The method according to claim 1, characterized in that the geogrid (13) is held in a tensioning frame (12) of a chain stitch embroidery or laying machine (49), which is driven so as to be movable at least in a horizontal direction.

3. The method according to claim 1, characterized in that the fiber bundles formed from the rovings (25) are stitched onto the taut geogrid (13) using a chain-stitch embroidery method in a load-bearing manner.

4. The method according to claim 1, characterized in that the tensioning frame (12) is driven so as to be movable at least in the X-Y direction (23, 48).

5. The method according to claim 1, characterized in that the laying machine (49) is driven in a controlled manner above the tensioning frame (12) so as to be movable at least in the Z-direction.

6. The method according to claim 1, characterized in that the loop knot (40) is formed as a chain stitch loop (44) and is produced by the hook-shaped end of a stitching needle (29, 30) that is driven so as to move in at least two spatial axes.

7. The method according to claim 1, characterized in that the completed loop knot (40) is mechanically and/or thermally set during or after its production.

8. The method according to claim 7, characterized in that the loop knot (40) is set by applying mechanical pressure and/or heat below its melting temperature.

9. The method according to claim 7, characterized in that the loop knot (40) is secured by melting a material that at least partially covers the loop knot (40).

10. The method according to claim 7, characterized in that the loop knot (40) is secured by applying an air- and/or UV-curing adhesive.

11. The method according to claim 7, characterized in that the material at least partially covering the loop knot (40) consists of one or more thermoplastic filaments (35) that are melted by a laser pulse.

12. The method according to claim 1, characterized in that the fiber bundles formed from the rovings (25) consist of alkali- and corrosion-resistant fibers made of plastics or bioplastics and/or natural fibers and/or glass fibers and/or carbon/carbon fibers and/or aramid fibers and/or, in particular, basalt fibers, or non-metallic biocompatible materials.

13. The method according to claim 1, characterized in that the fibers of the rovings (25) have a diameter ranging from a few 6 micrometers to over 50 micrometers, and a typical bundle consists of between 6,000 and 96,000 fibers and typically has a tex value of 150 to over 4,800 (g/km) and is used in the form of spools (16) with a typical weight of 30 kg and, for example, a length of over 10 km.

14. The method according to claim 1, characterized in that the fibers of the roving (25) are coated with a primer of aqueous resin and exhibit good absorption in the range of NIR LEDs or lasers in the range of 700 to 1,200 nm, and are thermally activated by localized or area-defined NIR irradiation, resulting in an increase in bonding at the intersection points (26) between the roving (25), the geogrid (13), and the fastening thread (47).

15. The method according to claim 1, characterized in that the geogrid (13) comprises knot-stiff or knot-stable and flexible grids of rovings (25) based on geosynthetics or geotextiles, and consists of alkali- and corrosion-resistant fibers made of plastics and/or bioplastics and/or natural fibers and/or glass fibers and/or carbon fibers and/or aramid fibers and/or, in particular, basalt fibers or non-metallic biocompatible materials.

16. The method according to claim 1, characterized in that the chain-stitch embroidery or laying machine (49) is an NC-controlled system that performs precise and automated laying processes on a geogrid (13) held taut in one or more tensioning frames (12), thereby enabling the laying/application of fiber bundles (25), in part without a fixed connection, along the load path, onto the geogrid (13).

17. The method according to claim 1, characterized in that the control of the needle movement of the chain-stitch embroidery or laying machine (49) is performed by computers in accordance with load-appropriate specified geometries, and can be supplemented in terms of precision by optoelectronic positioning, calibration, or optimization methods, and, if necessary, adapted to geometric deviations of the geogrids used, thereby compensating for any tolerances.

18. The method according to claim 1, characterized in that the chain-stitch embroidery or laying machine (49) has a typical laying area of 2 m×1 m and can be expanded to several meters up to approximately 8 m×2 m by arranging multiple units (49) side by side, and the tensioning frames (12) for securely holding the geogrid (13) are arranged accordingly for structures of such length.

19. A reinforcement based on a geogrid (13) comprising fiber bundles (25), manufactured according to claim 1.

20. A method of using the reinforcement according to claim 19 for the production of a fiber-reinforced concrete object with increased tensile strength, increased corrosion resistance, lower weight, higher temperature resistance, and the ability to create three-dimensional (3D) objects, preferably using basalt fibers.

21. A device for manufacturing a textile reinforcement for concrete components, wherein a laying machine (49) is arranged above a flat substrate in a manner controlled in at least two spatial axes, said substrate being fastened in a tensioning frame (12) that is controlled to move in at least one spatial plane, and rovings (25) consisting of fiber bundles can be secured to the flat substrate by means of a textile fastening thread (47) with fastening knots, characterized in that the substrate is formed as an open geogrid (13) consisting of intersecting grid bars (27), and that the rovings (25) are secured to the grid intersection points (26) of the geogrid (13) by means of a loop knot (40) of the fastening thread (47).

22. The device according to claim 21, characterized in that the laying machine (49) is equipped with an embroidery tool head (28) that is controlled to move in at least two spatial axes and carries a stitching needle (29) suitable for forming a loop knot (40).

23. The device according to claim 21, characterized in that the embroidery tool head (28) is arranged on a laying head (5) that is controlled to move in at least two spatial axes, and that a stitching needle (29) that processes the fastening thread (47) is arranged on said embroidery tool head.

24. The device according to claim 21, characterized in that a feed unit (21, 31, 32) for feeding the rovings (25) to the grid intersection point (26) of the geogrid (13) is arranged on the laying head (5).

25. The device according to claim 24, characterized in that the feed unit (21, 31, 32) consists of a guide eyelet (32) through which the roving (25) can be fed into a feed path (3) directed toward the grid intersection point (26).

26. The device according to claim 21, characterized in that an additional feed (4) for one or more thermoplastic filaments (35) to accompany the roving (25) is arranged on the laying head (5).

27. The device according to claim 26, characterized in that the additional feed of one or more thermoplastic filaments (35) to accompany the roving (25) consists of smaller guide eyes (33) arranged on the outer circumference of the larger guide eye (32), through each of which at least one thermoplastic filament (35) can be fed into a mixing head (36), which is arranged coaxially and upstream of the outlet orifice (37) of the feed unit (21, 31, 32).

28. The device according to claim 21, characterized in that a laser head (1) is fastened to the laying head (5) and is directed at the loop knot (40) at the grid intersection point (26) of the geogrid (13).

29. The device according to claim 21, characterized in that a flat reinforcement mesh covered with rovings (25) can be formed into a three-dimensional reinforcement cage (50) by a forming or bending unit.

30. The device according to claim 21, characterized in that it is suitable for carrying out a method for manufacturing a textile reinforcement for concrete structural elements, wherein, in a first method step, a flat substrate is provided, which is, in a second method step, covered with rovings (25) that are, in a third method step, secured to the substrate (13) using a fastening thread (47) with a textile knot (40, 44), characterized in that the substrate is formed as an open-mesh geogrid (13) consisting of intersecting grid bars (27), and that in the third step of the method, the rovings (25) are secured to the grid intersection points (26) of the geogrid (13) using a loop knot (40) of the fastening thread (47).
